(19) United States
(12) Patent Application Publication
(10) Pub. No.: US 2017/0114196 A1
(43) Pub. Date: Apr. 27, 2017

(54) COMBINED MATERIAL SYSTEM FOR ION EXCHANGE MEMBRANES AND THEIR USE IN ELECTROCHEMICAL PROCESSES

(71) Applicants: Thomas HÄRING, Stuttgart (DE); UNIVERSITÄT STUTTGART - INSTITUT FÜR CHEMISCHE VERFAHRENSTECHNIK, Stuttgart (DE); UNIVERSITÄT STUTTGART, Stuttgart (DE)

(72) Inventors: Thomas HÄRING, Stuttgart (DE); Jochen KERRES, Ostfildern (DE); Carlo MORANDI, Stuttgart (DE)

(21) Appl. No.: 15/318,225

(22) PCT Filed: Jun. 12, 2015
(86) PCT No.: PCT/DE2015/000294

§ 371 Date: Dec. 12, 2016

(30) Foreign Application Priority Data
Jun. 12, 2014 (DE) 10 2014 009 170.8

(51) Int. Cl. C08J 5/22; H01M 8/1027; H01M 2/16; C08J 3/24; H01M 8/1034; H01M 8/1039; C25B 13/08; B01D 71/62; H01M 8/1032

(52) U.S. Cl. CPC C08J 5/2262; B01D 71/62; H01M 8/1027; H01M 2/1653; H01M 8/1032; H01M 8/1034; H01M 8/1039; C25B 13/08; C08J 3/246; C08J 5/2256; B01D 2325/40; C08J 2379/04; C08J 2471/12; C08J 2481/06; C08J 2381/06; C08J 2479/04; C08J 2371/12; C08J 2371/10

(57) ABSTRACT

Described is a method for producing covalently and/or ionically cross-linked blend membranes from a halomethylated polymer, a polymer comprising tertiary N-basic groups, preferably polybenzimidazole, and, optionally, a polymer comprising cation exchanger groups such as sulfonic acid groups or phosphonic acid groups. The membranes can be tailor-made in respect of the properties thereof and are suitable, for example, for use as cation exchanger membranes or anion exchanger membranes in low-temperature fuel cells or low-temperature electrolysis or in redox flow batteries, or—when doped with proton conductors such as phosphoric acid or phosphonic acid—for use in medium-temperature fuel cells or medium-temperature electrolysis.

### SUMMARY

Multi-use membranes (use as AEM, H₃PO₄-doped HT membranes, HT-HyS electrolysis membranes, membranes as separators for redox-flow batteries)

mixing a halomethylated polymer with a basic polymer (eg PBI: F₆PBI or PBIOO) in a dipolar aprotic solvent such as DMSO or DMAc, NMP, etc.

Covalent crosslinking by heating to 80-180° C. for 2-24 hours (1- or 2-sided imidazolization)

Optional subsequent sulfonation of the polymer films by incorporation in 60-90% H₂SO₄ at T=25-180° C. for 0.5-24 hours (see sulfuric acid-treated HyS electrolysis membranes)→both ionically and covalently crosslinked blend membranes are obtained)

Blending a partially phosphonated polymer (neutralized with an amine) with a PBI (preferably PBIOO, ABPBI, F₆PBI or Celazol® Hozol®), adding a bisphenol or bisthiophenol (e.g., 4,4′-diphenol or TBBT and others), Addition of an amine until bis(thio)phenol is completely neutralized (color change of the solution), doctoring the solution and evaporating the solvent at 90-170° C., followed by 1-24 hours of heating at 100-200° C. for covalent crosslinking of F by thiolate or phenolate groups (nucleophilic substitution)

Mixing a halomethylated polymer with a PBI (preferably ABPBI, F₆PBI or PBIOO) in DMAc, cooling to 0-5° C., admixing any tertiary amine (eg TEA, DABCO, ABCO), rapid homogenization and doctoring, evaporation at 60-150° C., post-treatment in sulfuric acid (60-90% H₂SO₄), washing of the film→covalent-ionically cross-linked acid-base blend membrane

Mixing of a halomethylated polymer with a PBI (F₆PBI or PBIOO) in DMAc, cooling to 0-5° C., addition of an amine (eg TEA, DABCO, ABCO) and a diiodoalkane, rapid homogenization and doctoring, evaporation at 90°−130° C., post-treatment in sulfuric acid (60-90% H₂SO₄), washing of the film→covalent-ionically cross-linked acid base blend membrane

mixing a halomethylated polymer with a PBI (F₆PBI or PBIOO) in DMAc, cooling to 0-5° C., adding a sulfonated polymer and a monoamine (NMM), rapid homogenization and knife coating or casting, evaporation at 80-150° C., aftertreatment in diamine (TMEDA, DABCO) or in monoamine (NMM) at RT-100° C., washing of the film→Covalent-ionically cross-linked acid base blend membranes.

Mixing a halomethylated polymer with a PBI (F₆PBI or PBIOO) in DMAc, cooling to 0-5° C., adding (sulfonated polymer and) an N-alkylated or arylated benz)imidazole (Melm or EtMelm), rapid homogenization and doctoring or casting, evaporation at 80-150° C., washing the film→Covalent-ionically cross-linked acid-base blends.

### STATE OF THE ART

Phosphoric acid-doped polybenzimidazole (PBI) for use in fuel cells is based on the work of Savinell et al¹. The advantage of the PBI/H₃PO₄ composite membranes is that the phosphoric acid takes over the H⁺-conduction instead of water², which makes it possible to apply this type of membrane at fuel cell operating temperatures between 100 and 200° C. The disadvantage of this type of membrane is the possible bleeding out of the phosphoric acid from the composite membrane as the fuel cell temperature falls below 100° C. and condensing product water floats phosphoric acid molecules out of the membrane³. The liberated phosphoric acid can then cause severe corrosion damage in the fuel cell system. A further disadvantage of H₃PO₄-doped PBI membranes is the chemical degradation of the PBI in the fuel cell⁴. Several strategies have been implemented in the R & D of this type of membrane to reduce the degradation of PBI in fuel cell operation. One strategy is the preparation of acid-base blend membranes from PBI and acidic polymers, whereby the acidic polymer takes over the task of an ionic crosslinker by proton transfer from the acidic polymer to the PBI-imidazole. Acid base blend membranes have been researched and developed in the working group of the inventors⁵ and partly modified in cooperation with the working group of Q. Li at the Danish Technical University (DTU) for medium temperature membranes within the framework of an EU project. It was found that the base-excess acid-base blend membranes exhibited better chemical stability than pure PBI, which can be attributed to the ionic crosslinking sites in the blend membranes⁶. In the working group, base-acid blend membranes were prepared from different PBIs such as PBIOO and F₆PBI with phosphonated poly(pentafluorstyrene)⁷ and doped with H₃PO₄⁸. The membranes (blend membrane of 50% by weight of PBIOO and 50% by weight of PWN) showed a mass loss of only 2% after 144 hours in Fenton's reagent, whereas pure PBIOO had a mass loss of 8% after the same storage period in Fenton's reagent. Another way to increase the chemical stability of PBI-type membranes is the preparation of covalently cross-linked PBI membranes described by Q. Li et al. and other research groups. The PBI can be crosslinked with a low molecular weight crosslinker, for example bisphenol A bisepoxide⁹, divinyl sulfone¹⁰ or a high molecular weight crosslinker, such as chloromethylated PSU¹¹ or bromomethylated polyether ketone¹². Further attempts to increase the stability of PBI membranes include the preparation of PBI membranes modified with nanoparticles¹³, or the preparation of partially sulfonated PBI, which is cross-linked intra- or intermolecularly by proton transfer from the acidic group to the imidazole group^{14,15}. It has also already been reported that PBI is grafted onto the side chain containing phosphonic acid groups, forming ionic crosslinking sites between the basic PBI main chain and the acid side chains^{16,17}. Of the PBI membranes of the prior art, the blended membranes of PBI and poly (2,3,5,6-tetrafluorstyrene-4-phosphonic acid) synthesized by us show the best stability against radical degradation (determined ex situ by the Fenton Test⁸). The literature also contains blends of polybenzimidazole and dialkylated polybenzimidazole, which are used as stable anion exchange membranes^{18, 19, 20}. A variety of different polymers are currently used as backbone polymers for the production of novel AEMs: among others, ethylene-tetrafluoroethylene, polyetherether ketones, polyethersulfone, poly (ether sulfone ketone), polyethylene, polyphenylene oxide, polystyrene, polyvinyl acetate, poly (vinylbenzyl chloride), polyvinylidene fluoride. Table 1 shows a comprehensive compilation of relevant non-commercial AEMs, which are also compared to the benchmark membrane Tokuyama A201. The 28 μm thick commercial Tokuyama membrane A201 (development cords A006) has a hydroxide conductivity of approx. 40 mS·cm⁻¹ (23° C. and RH=90%) according to the manufacturer²¹. The corresponding IEC value is 1.7 meq·g⁻¹. The benchmark membrane was characterized for the purposes of the present invention under the same measuring conditions.

TABLE 1
Relevant membranes for the application in fuel cells

| | | IEC | conductivity | Measurement | |
|---|---|---|---|---|---|
| Membrane and producer | Chemical structure | [meq · g⁻¹] | [mS · cm⁻¹] | conditions | Remarks |
| Tokuyama o. Ltd., Japan | hydrocarbon-backbone, | 1.7 | ca. 40 | OH⁻ form, 23° C., | No information regarding |
| A 201, development code: | quart. ammonium | | | 90% rel. hum. | chemical, thermal and |
| A-006 | | | | | mechanical stability |
| C.-C. Yang (2006a)²² | PVA-ZrO₂-KOH | — | 267 | OH⁻ form, 20° C., | No information regarding |
| Nanocomposites | | | | 20% rel. hum. | thermal and mechanical |
| | | | | | stability |
| El Moussaoui | ETFE/PE, functionalized with | 1.5 | 55 | OH⁻ form, 20° C., | No information |
| et al. (2006)²³ | chlorosulfone/TMPDA and | | | 1 N NaOH | regarding thermal and |
| Radiation-induced | grafted with styrene/DVB | | | | mechanical stability |
| grafting | | | | | |
| Varcoe et al (2007b)²⁴ | ETFE, functionalized with | 0.74 | 30 | OH⁻ form, 30° C., | No information regarding |
| Radiation-induced | benzyltrimethylammonium | | | completely hydrated, | chemical, and mechanical |
| grafting | | | | water | stability |
| Wu und Xu (2008)²⁵ | Chloracetylated PPE | ca. 2.0 | 32 | OH⁻ form, 20° C., | No information regarding |
| Blend membrane | und Br-PPE, | | | 100% rel. hum. | chemical stability |
| | quaternized with TMA | | | | |
| Hibbs et al (2009)²⁶ | PPE, functionalized with | 1.57 | 50 | OH⁻ form, 30° C., | Bad mechanical |
| Homogeneous | benzyltrimethylammonium | | | completely hydrated, | properties, |
| membrane | | | | water | WA* = 122 wt % |
| Robertson et al | Olefin-copolymers, | 2.3 | 68.710 | OH⁻ form, 22° C., | Bad mechanical stability |
| (2010b)²⁷ | funct. with | | | Cl⁻ form, 22° C. | in alkaline medium |
| Homogeneous | tetraalkylammonium | | | | |
| membrane | | | | | |
| Kostalik (2010b)²⁸ | PE, functionalized with | 1.5 | 48 | OH⁻ form, 20° C., | Bad mechanical |
| Homogeneous | tetraalkylammonium | | | degassed water | properties, |
| membrane | | | | | WA* = 132 wt % |
| Wang et al. (2010b)²⁹ | PES, functionalized with | 2.15 | 67 | OH⁻ form, 20° C., | Shortage of |
| Homogeneous | guanidinium groups | | | completely | mechanical |
| membrane | | | | hydrated, | stability |
| | | | | water | |
| Tanaka et al. (2010)³⁰ | SPESK and fluorenyl units | 2.54 | 50 | OH⁻ form, 30° C., | No information |
| Multiblock copolymer | | | | completely hydrated, | regarding chemical |
| | | | | water | stability |
| Tanaka et al. (2011)³¹ | SPESK and fluorenyl units | 1.93 | 96 | OH⁻ form, 40° C., | Bad mechanical properties, |
| Multiblock copolymer | | | | degassed, deionized | WA = 112 wt % |
| | | | | water | (30° C.) |
| Zhao et al. (2011)³² | PES, quaternized with | 1.62 | 29 | OH⁻ form, 20° C., | No information |
| Multiblock copolymer | benzyltrimethylammonium | | | 100% rel. hum. | regarding chemical |
| | | | | | stability |
| Faraj et al. (2011)³³ | SBS-g-VBC, | 1.21 | ca. 40 | OH⁻ form, 30° C., | Bad mechanical |
| Multiblock copolymer | functionalized with | | | completely | properties, WA more |
| | DABCO | | | hydrated | than 160 wt % |
| Ran et al. (2012)³⁴ | Br-PPE, quaternized | 2.4 | 32 | OH⁻ form, 20° C., | Bad to moderate |
| Homogeneous | with 1-methylimidazole | | | completely | mechanical |
| membrane | | | | hydrated, water | properties |
| | | | | | WA = 84 wt % |
| Lin et al. (2012)³⁵ | Br-PPE, functionalized | 2.69 | 71 | OH⁻ form, 25° C., | moderate mechanical |
| Homogeneous | with guanidinium | | | completely | stability SI = 45% |
| membrane | groups | | | hydrated | (80° C.) |
| Wang et al. (2014)³⁶ | PEEK, quaternized | ca. 1.9 | 33.4 | OH⁻ form, 25° C., | Bad to moderate |
| Homogeneous | and crosslinked | | | completely | mechanical |
| membrane | with DABCO | | | hydrated, | properties, |
| | | | | water | WA = 88 wt % |
| Yan et al. (2014)³⁷ | PEEK, | 1.19 | 61 | OH⁻ form, 20° C., | Bad mechanical |
| Homogeneous | functionalized with | | | completely | properties, |
| membrane | phosphonium groups | | | hydrated, | WA = 172 wt % |
| | | | | water | |

### DESCRIPTION OF THE INVENTION

In the framework of this invention, PBI blend membranes, which are covalently and/or ionically cross-linked, are described, which are produced with halomethylated and optionally sulfonated and/or phosphonated polymers and are tailor-made in terms of their properties. If desired, the blend membranes are additionally covalently crosslinked, for example by the addition of a low molecular weight and/or a macromolecular crosslinker. Depending on the chosen composition, the membranes can be used in electrochemical processes as low-temperature cation exchange membranes, low-temperature anion exchange membranes (temperature range unpressurized to 100° C. or under pressure up to 150° C.) or doped with protonic conductors such as phosphoric acid and/or phosphonic acids, they can be used in the medium temperature range up to 220° C. Examples of electrochemical processes in which these membranes are to be used are:

A) low-temperature hydrogen fuel cells or electrolysis (0-100° C. depressurized or 0-130° C. under pressure)

(B) low-temperature direct fuel cells with fuels from the chemical group of alcohols such as methanol, ethanol, ethanediol, glycerol or ether fuels such as dimethyl ether or diethyl ether or various glymes (glyme, diglyme, triglyme . . . )

C) Intermediate temperature fuel cells or electrolysis (0-220° C.)

D) Intermediate temperature depolarized electrolysis (eg SO₂ electrolysis)

E) Redox-flow batteries (for example all-vanadium, iron-chromium, etc.)

In the following, exemplary membrane types which are suitable for the respective electrochemical applications are described.

### Anion-Exchange Blend Membranes for H₂ Fuel Cells, DMFC, Redox-Flow Batteries, Alkaline Electrolysis

The anion exchange membranes consist of the following components:

A) a polybenzimidazole (PBI) as a matrix polymer, the following polybenzimidazoles being exemplified as ABPBI, PBI Celazole, p-PBI, F₆PBI, SO₂PBI and PBIOO. The recurring occurrence of the benzimidazole moiety in the main chain or side chain of the polymer is characteristic of the polybenzimidazoles used.

B) a halomethylated polymer (main chain selected from the group of polystyrenes and polystyrene copolymers, aryl main chain polymers (for example, polyether sulfones, polyether ketones, polysulfones, polybenzimidazoles, polyimides, polyphenylene oxides, polyphenylenesulfides) and any combinations as random copolymers, block copolymers, alternating copolymers), which carry the functional group —CR₂HaI with R=HaI, alkyl radical, aryl radical and HaI=Cl, Br, I.

C) an alkyl halide (monohaloalkane, dihaloalkane, oligohaloalkane, monobenzyl halide, dibenzyl halide, tribenzyl halide, etc.), diiodopropane, diiodobutane, diiodopentane, diiodohexane diiodheptane, diiodoctane, diiodononane, diiododecane, etc.

D) optionally a monoalkylated polybenzimidazole

E) any polymer having cation exchange groups, eg, SO₃X, PO₃X₂, COOX, SO₂X and X═H, alkali metal, alkaline earth metal, ammonium, imidazolium, pyridinium.

The anion exchange groups of the blend are in molar excess over the other functional groups such as, for example, cation exchange groups. The anion exchange polymer blend membranes can thereby obtain the anion exchange groups in the following ways:

a) The solution of the mixture of the above polymers in a dipolar aprotic solvent (NMP, DMAc, DMF, DMSO, NEP, sulfolane, etc.), a basic nitrogen compound, such as for example, tertiary amine NR₃ (R=alkyl, aryl), Pyridine, (tetralkyl) guanidine, alkyl or aryl imidazole. The chemical compound containing tertiary nitrogen may contain one or more tertiary nitrogen atoms. The tertiary nitrogen compound may also be an oligomer (eg, a polyvinylpyridine). Thereafter, the polymer solution is doctored, sprayed or cast on a substrate, and the solvent is evaporated. Thereafter, the resulting membrane is aftertreated:
aftertreatment in water to remove chemical and solvent residues
if appropriate aftertreatment in dilute alkali or alkaline earth metal hydroxide solution for the exchange of the HaI-counterions against OH ions
optionally alkylation of the remaining tertiary N groups (imidazole, guanidine) with a non-carcinogenic alkylating agent
Wash with water to remove chemical and solvent residues

b) The mixture of the above polymers in a dipolar aprotic solvent is stirred or poured and the solvent removed. Thereafter, the nitrogen groups of the resulting membrane are quaternized by immersing them in a tertiary amine, an amine solution or a mixture of various tertiary amines. The aftertreatment of the membrane is then carried out in the following manner:
aftertreatment in water to remove chemical and solvent residues
if appropriate aftertreatment in dilute alkali or alkaline earth metal hydroxide solution to replace the HaI-counterions against OH⁻ ions
optionally alkylation of the remaining tertiary N groups (imidazole, guanidine) with a non-carcinogenic alkylating agent
wash with water to remove chemical and solvent residues.

Surprisingly, it has been found that homogeneous, mechanically and chemically very stable anion exchange membranes can be produced by means of the described processes, which are substantially more stable than anion exchange membranes of the prior art.

Base Excess PBI Blend Membranes (Covalently or Covalent-Ionically Cross-Linked) for Doping with Phosphoric Acid or Phosphonic Acids for Application in Electrochemical Processes in the Temperature Range from 100 to 220° C.

These membranes consist of a molar excess of a polybenzimidazole wherein the polybenzimidazole may be differently cross-linked to limit its phosphoric acid or water uptake. The membranes may consist of the following components:

a) a polybenzimidazole (PBI) as a matrix polymer (as example ABPBI, PBI Celazole, p-PBI, F₆PBI, SO₂PBI, PBIOO and any other polybenzimidazoles)

b) a halomethylated polymer (main chain selected from the group of polystyrenes and polystyrene copolymers, aryl main chain polymers (for example, polyether sulfones, polyether ketones, polysulfones, polybenzimidazoles, polyimides, polyphenylene oxides, polyphenylenesulfides) and any combinations as random copolymers, block copolymers, alternating copolymers), which carries the functional group —CR₂HaI with R=HaI, alkyl radical, aryl radical and HaI═Cl, Br, I.

c) an alkyl halide (monohaloalkane, dihaloalkane, oligohaloalkane, monobenzyl halide, dibenzyl halide, tribenzyl halide, etc.), diiodopropane, diiodobutane, diiodopentane, diiodohexane diiodheptane, diiodoctane, diiodononane, diiododecane, etc.

d) optionally a monoalkylated polybenzimidazole

e) any polymer having cation exchange groups, eg, SO₃X, PO₃X₂, COOX, SO₂X and X═H, alkali metal, alkaline earth metal, ammonium, imidazolium, pyridinium.

Covalently cross-linked PBI blend membranes can consist of components a), b), c), d) and optionally a polymeric sulfinate RSO₂X, covalent-ionically cross-linked membranes additionally contain cation exchange polymers which are listed under e).

After membrane production, the membranes are doped with phosphoric acid or phosphonic acid. The phosphoric acid/phosphonic acid absorption can be controlled by the concentration of the acid, by the bath temperature and by the residence time of the membrane in the phosphoric acid/phosphonic acid bath.

A covalently cross-linked PBI is obtained, for example, by:

a) mixture of the PBI with a halomethylated polymer wherein the halomethylated polymer reacts with one or both N-atoms of the imidazole group of the PBI by alkylation (FIG. 1).

b) mixing the PBI with a monoalkylated PBI, a tertiary diamine (eg DABCO), a diiodoalkane (eg diiodobutane) and a polymeric sulfinate. There are various possibilities for the formation of a polymeric network of these components, which are listed in FIG. 2, FIG. 3 and FIG. 4.

A covalent-ionically cross-linked membrane is obtained as follows below:

a) a phosphonated and/or sulfonated polymer is added to the polymer mixture before evaporation of the solvent.

b) the polymer components of the membrane are subsequently sulfonated by aftertreatment of the membrane in a sulfuric acid bath of varying concentrations (30-100% H₂SO₄, depending on the reactivity of the polymers in the blend). Protonation of the imidazole groups of the PBI by the sulfonic acid groups subsequently introduced leads to ionic crosslinking sites.

c) If the polymer mixture also contains highly fluorinated aromatic polymers whose F atoms can be replaced nucleophilically by phosphonic acid groups (for example by the phosphonation reaction from⁷), the membrane is introduced into a solution containing tris(trimethylsilyl) phosphite. A part of the aromatic F is replaced by phosphonic acid silyl ester groups, which can be readily hydrolyzed to free phosphonic acid groups by boiling with water. Nucleophile-replaceable aromatic F bonds can also be replaced by other functional groups, for example by thiol groups, which can be used in a further step for crosslinking.

Surprisingly, it has been found that homogeneous, mechanically and chemically very stable intermediate temperature cation exchange membranes can be produced by means of the described processes which are more stable than intermediate-temperature cation exchange membranes of the prior art (for example, doped pure polybenzimidazoles).

### Acid-Excess Blend Membranes (Cation Exchange Membranes) for H₂ Fuel Cells, DMFC, PEM Electrolysis, Redox-Flow Batteries

These membranes consist of the following blend components:

a) cation exchange membranes with the sulfonic acid group SO₃X or the phosphonic acid group PO₃X₂ (X═H, alkali metal, alkaline earth metal, ammonium, imidazolium, pyridinium)

b) a polybenzimidazole (PBI) as a matrix polymer (as example ABPBI, PBI Celazole, p-PBI, F₆PBI, SO₂PBI, PBIOO and any other polybenzimidazoles)

c) A halomethylated polymer (any main chain selected from the group of polystyrenes and polystyrene copolymers, aryl main chain polymers (for example, polyether sulfones, polyether ketones, polysulfones, polybenzimidazoles, polyimides, polyphenylene oxides, polyphenylene sulfides) and any combinations as random copolymers, block copolymers, alternating copolymers), which carry the functional group —CR₂HaI with R=HaI, alkyl radical, aryl radical and HaI═Cl, Br, I.

d) optionally an alkyl halide (monohaloalkane, dihaloalkane, oligohaloalkane, monobenzyl halide, dibenzyl halide, tribenzyl halide, etc.), diiodopropane, diiodobutane, diiodopentane, diiodohexane diiodheptane, diiodoctane, diiodononane, diiododecane, etc.

e) optionally a monoalkylated polybenzimidazole

In these membranes, the acidic groups are in molar excess so that these membranes are cation-conductive. The blend membranes are covalently crosslinked when they contain the components a), b), c) and optionally d) and e). By reacting the blend components b) and c) with one another (and optionally d) and e)), quaternary positively charged nitrogen groups are formed which form ionic crosslinking sites with the acid anions: [SO₃]⁻⁺[NR₄] (R=alkyl, aryl) which form stronger electrostatic interactions with one another than when only ionic crosslinking sites form between the acidic groups and protonated benzimidazolium groups, as would be the case in the mixture between the acidic polymer and the non-alkylated PBI. It is expected that the crosslinking sites [SO₃]⁻⁺[NR₄] (R=alkyl, aryl) together with the covalent crosslinking of the blend components b) and c) (and optionally still d) and e)) in redox-flow batteries (RFB) reduce the permeability of the membranes for metal cations, which minimizes the efficiency losses of the RFB application.

Surprisingly, it has been found that homogeneous, mechanically and chemically very stable low-temperature cation exchange membranes which are more stable than low-temperature cation exchange membranes of the prior art (for example acid-base blend membranes of cation exchange polymers with weak polymeric bases) can be produced by means of the described processes. In particular, it is surprising that the membranes of the invention are more stable than conventional aromatic acidic polymers, in particular also for use in redox-flow batteries in which the membranes are subjected to strongly oxidizing conditions.

### Summary of the Components of the 3 Membrane Types

Membranes are claimed which can be used in various electrochemical processes depending on the proportion of the respective main blend components. The main membrane types and their respective fields of application are listed in the tabular overview below (Table 2).

TABLE 1
Summary of the components of the 3 membrane types

| | Cation- | | Mono- | Halome- | Alkyl- | Tertiary | H₃PO₄ or |
|---|---|---|---|---|---|---|---|
| | exchange | | alkylated | thylated | halo- | amine, | phosphonic |
| Membrane type | polymer | PBI | PBI | polymer | genide | imidazole | acid |
| Low-temperature | + | − | 0 | − | 0 | 0 | no |
| cation-exchange | | | | | | | |
| membranes¹ | | | | | | | |
| Anion-exchange | − | + | 0 | + | 0 | + | no |
| membranes² | | | | | | | |
| Intermediate- | − | + | 0 | − | 0 | 0 | yes |
| temperature | | | | | | | |
| membranes³ | | | | | | | |

+ molar excess
0 optionally
− molar shortage
¹cation conductor
²anion conductor
³proton conductor via (poly)phosphoric and/or phosphonic acid

Surprisingly, it was found that the membranes can be used either as cation exchange, anion exchange or intermediate temperature membranes, depending on the proportion of the various blend components listed in Table 2. In particular, it is surprising that multi-layered membranes (from alternating cation-exchange and anion-exchange layers) can also be produced, which have outstanding properties, particularly in the case of use in redox flow batteries, such as extremely high chemical stability and very low cation permeabilities.

### DESCRIPTION OF THE FIGURES

FIG. 1 depicts the reaction of a PBI with a halomethylated polymer.

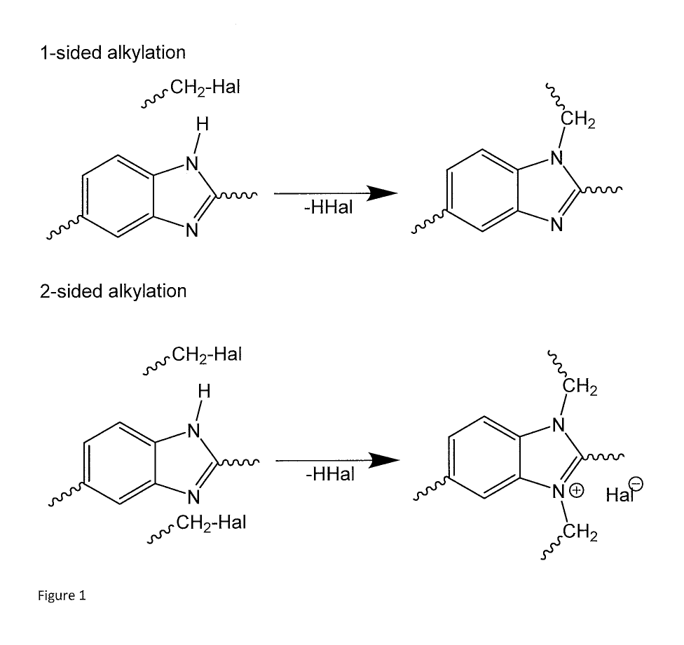

FIG. 2 shows the reaction of a polymeric sulfinate with diiodobutane and DABCO

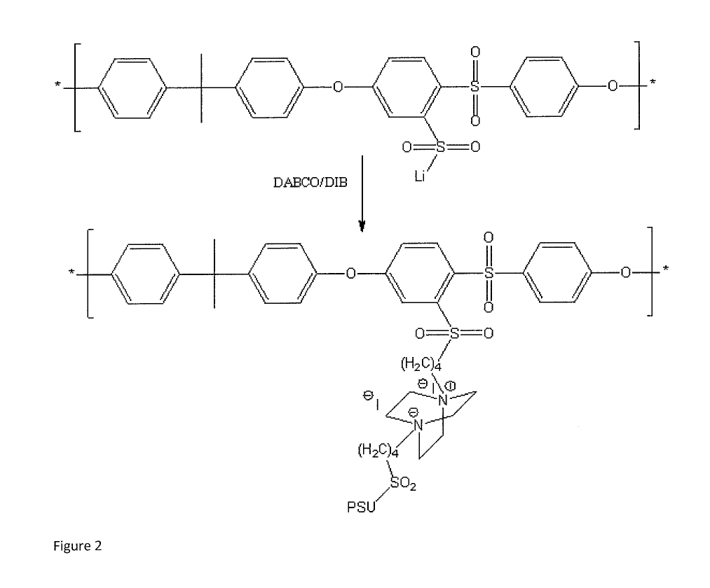

FIG. 3 shows the reaction of monomethylated PBIOO with diiodobutane and DABCO

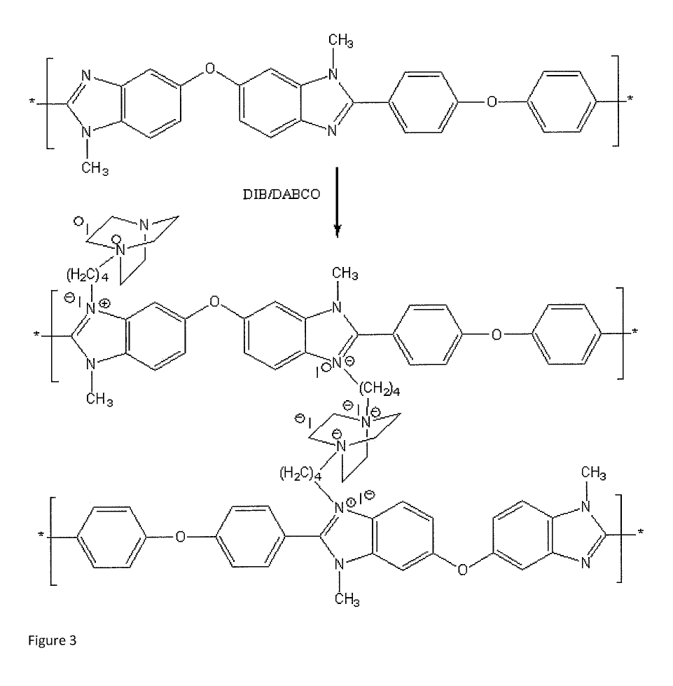

FIG. 4 shows the reaction of monomethylated PBIOO with a polymeric sulfinate and with diiodobutane.

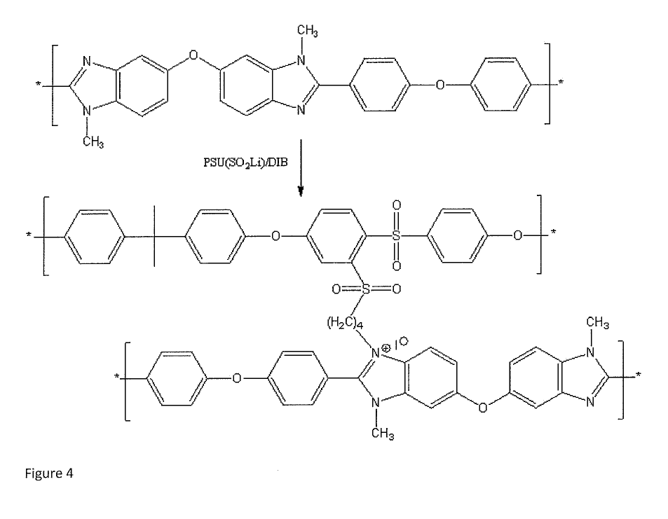

FIG. 5 shows the structure of the polymers used in Example 1.

FIG. 6 depicts the TGA curve of membrane MJK-1885.

FIG. 7 shows the conductivity as a function of the temperature of a H₃PO₄-doped 1885 membrane.

FIG. 8 shows the polymer blend components of membrane MJK-1959.

FIG. 9 shows the covalent and ionic crosslinking in the blinding membrane MJK 1959.

FIG. 10 shows the polymer blend components of membrane MJK-1932.

FIG. 11 shows the TGA curve of the membrane MJK-1932.

FIG. 12 shows the polymeric blend components of membrane MJK-1957.

FIG. 13 shows the polymer blend components of the NMM/DABCO quaternized membrane 54-PAK18r-60-F6PBI-SAC-15.

FIG. 14 depicts the degree of crosslinking as a function of the SAC content in the polymer solution for NMM-DABCO quaternized membranes from PAK18r-60-F6PBI

FIG. 15 shows the comparison of the chloride conductivities (1 M NaCl, RT) of the alkylimidazole-quenched PPO-PBIOO membranes and the commercial Tokuyama membrane A201 (development code A006).

FIG. 16 shows the TGA curves of alkylimidazole-quaternized membranes.

FIG. 17 shows the covalent and ionic cross-linking with the 40-PPO-50-F6PBI-SAC-5-NMM-TMEDA blend membrane

FIG. 18 shows the TGA curves of PPO-F6PBI membranes, which are (37) only covalently and covalent-ionically (40) cross-linked.

FIG. 19 shows the TGA curves of PPO-F6PBI ionically covalently cross-linked membranes, quaternized and crosslinked with NMM/DABCO.

FIG. 20 shows the TGA curves of PPO-F6PBI ionically covalently cross-linked membranes quaternized with NMM.

FIG. 21 shows the structure formula (repeat unit) of PBIOO and PVBCI.

### APPLICATION EXAMPLES

### Example 1: HIPEM from PBI, Halomethylated Polymer (Covalently Cross-Linked (Membrane MJK 1885)

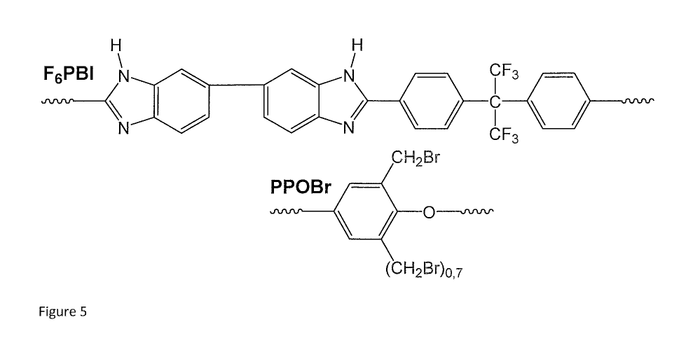

0.75 g of the polybenzimidazole F₆PBI is used as a 4% solution in N, N-dimethylacetamide (DMAc) as a 10 wt % solution in DMAc with 0.321 g of bromomethylated polyphenylene oxide (PPOBr, degree of bromination 1.7 CH₂Br per PPO repeat unit) (the chemical structure of the blend components is depicted in FIG. 5). After homogenization, a membrane is doctored on a glass plate from this solution, and the solvent is evaporated at 140° C. in a convection drying oven. The membrane is then removed under water and after-treated as follows: 48 hours of 10% HCl at 90° C., then 48 hours of deionized water at 60° C.

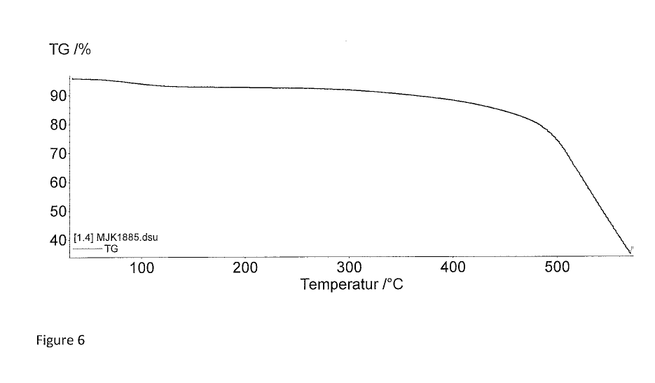

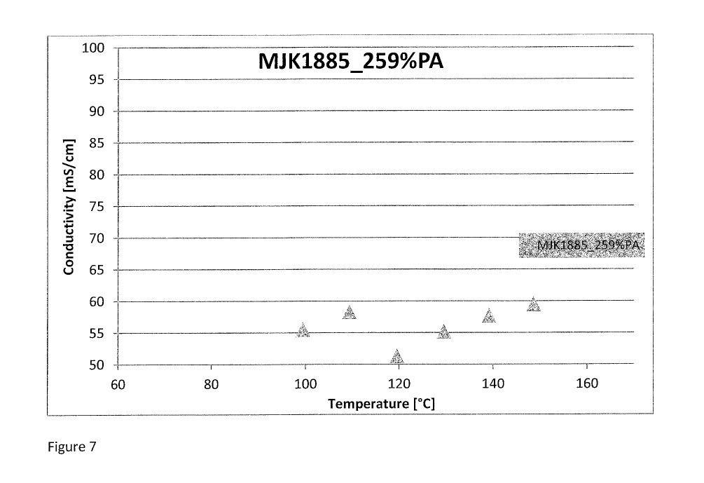

The membrane is then characterized as follows:
Thermogravimetry (TGA) in 65% O₂, the TGA curve of the membrane is presented in FIG. 6
extraction with DMAc at 90° C. (4 days)→extraction residue (insolubles 88.9%)
Fenton's test: after 96 hours in Fenton's reagent mass loss of 7.5%
doping with 85% H₃PO₄ (259% doping degree), the conductivity curve is depicted in FIG. 7.

### Example 2: HTPEM from P81, Halomethylated Polymer, Tertiary Amine, Sulfonated Polymer (Covalent-Ionically Cross-Linked) (MJK-1959)

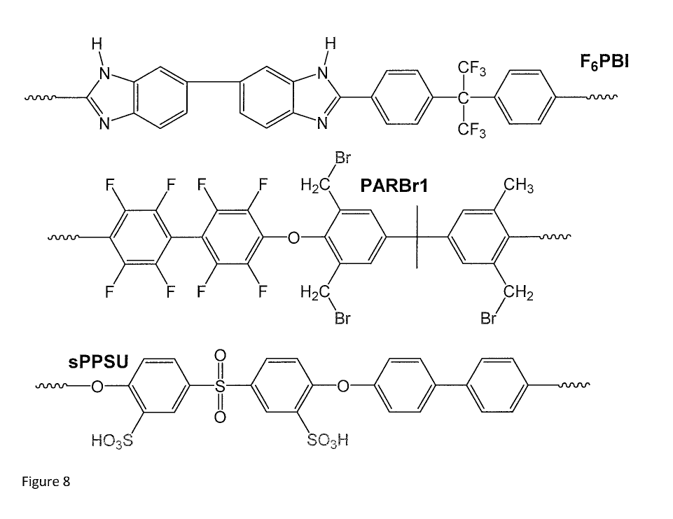

1.4 g of F₆PBI are mixed as a 5% solution in DMAc with 0.3 g of PARBr1 as a 5% solution in DMAc and 0.3 g of the sulfonated polymer sPPSU as well as 0.488 g of 1-ethyl-2-methylimidazole (the polymer structures are shown in FIG. 8).

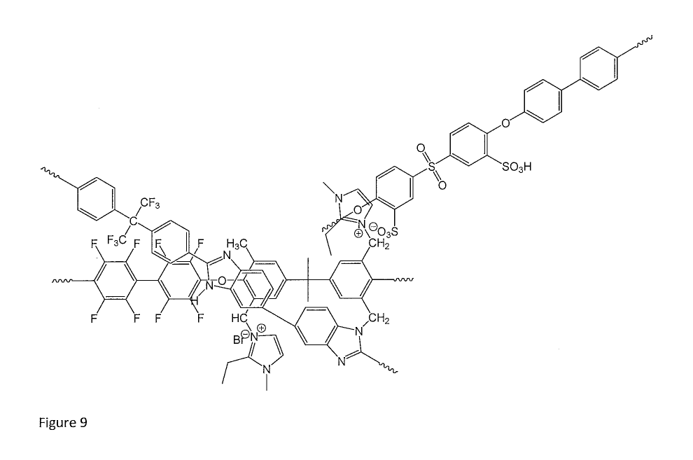

After homogenization, a membrane is doctored on a glass plate from this solution, and the solvent is stripped off at 140° C. in a convection drying oven. The membrane is then peeled off under water and after-treated as follows: 48 hours of 10% HCl at 90° C., then 48 hours of deionized water at 60° C. FIG. 9 shows the blend of the PBI with the quaternized polymer. Reaction of a small part of the CH₂Br groups with the imidazole-N—H under alkylation produces covalent crosslinking bridges. The membrane is then characterized as follows:
Thermogravimetry (TGA) in 65% O₂
extraction with DMAc at 90° C. (4 days)→extraction residue (insoluble parts %)
Fenton's test: after 96 hours in Fenton's reagent mass loss of %

Doping with 85% H₃PO₄ (259% doping degree), the conductivity curve is presented in FIG. 7.

### Example 3: AEM from PBI, Halomethylated Polymer, Tertiary Amine, Sulfonated Polymer (Covalent-Ionically Cross-Linked) (Membrane MJK-1932)

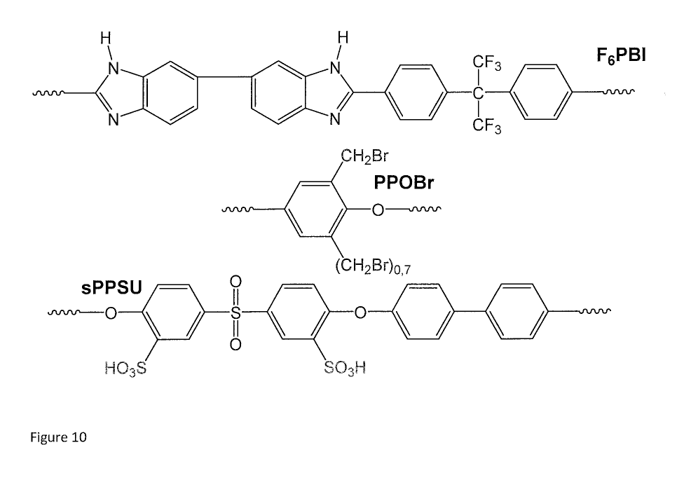

0.5 g of F₆PBI are mixed as a 5% solution in DMAc with 0.5 g of PPOBr as a 5% solution in DMAc and 0.107 g of the sulfonated polymer sPPSU and 1.08 ml of the tertiary amine N-methylmorpholine (the polymers of the blending componentsare depicted in FIG. 10).

After homogenization, a membrane is doctored on a glass plate from this solution, and the solvent is stripped off at 140° C. in a convection drying oven. The membrane is then removed under water and after-treated as follows: 48 hours of 10% HCl at 90° C., then 48 hours of deionized water at 60° C. Reaction of a small part of the CH₂Br groups with the imidazole-N—H under alkylation produces covalent crosslinking bridges.

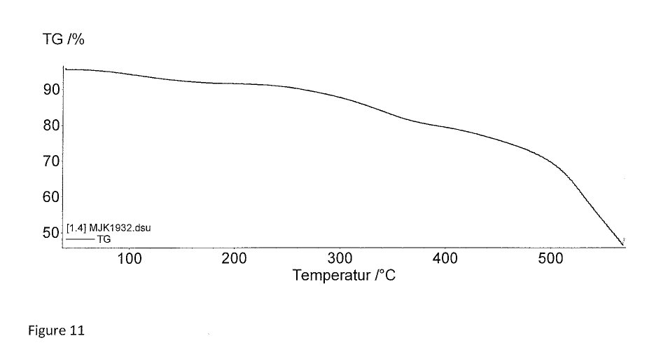

The membrane is then characterized as follows:
Thermogravimetry (TGA) in 65% O₂ (the TGA curve is shown in FIG. 11)
extraction with DMAc at 90° C. (4 days)→extraction residue (insoluble parts 93.9%)

Thickness 105 μm
chloride conductivity (RT, 1 M NaCl): 4.88 mS/cm
IEC: 2.8 mmol/g
Chemical stability (90° C., 1 M KOH)
IEC (after 5 d): 84.6% of the original value
IEC (after 10 d): 74.3% of the original value
Conductivity: (after 5 d): 56.1% of the original value.

### Example 4: CEM from Sulfonated Polymer, PBI, Halomethylated Polymer, Tertiary Amine (Covalent-Ionically Cross-Linked) (Membrane MJK-1957)

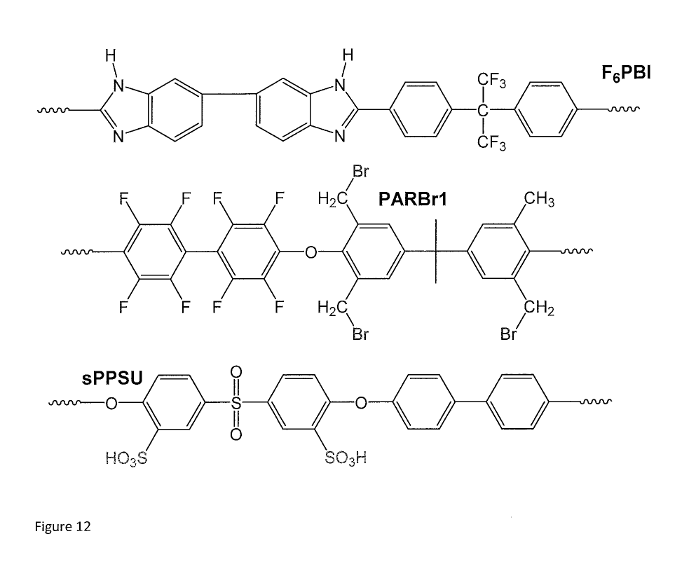

0.12 g of F₆PBI are mixed as a 5% solution in DMAc with 0.12 g of PARBr1 as a 5% solution in DMAc and 2 g of the sulfonated polymer sPPSU and 0.195 g of 1-ethyl-2-methylimidazole (the polymers of the blending components are shown in FIG. 12).

After homogenization, a membrane is doctored on a glass plate from this solution, and the solvent is stripped off at 140° C. in a convection drying oven. The membrane is subsequently removed under water and treated as follows: 48 hours of 10% HCl at 90° C., then 48 hours of demineralized water at 60° C. Covalent cross-linking bridges are formed by reaction of a small part of the CH₂Br groups with the imidazole N—H via alkylation.

The membrane is then characterized as follows:
Thermogravimetry (TGA) in 65% O₂
extraction with DMAc at 90° C. (4 days)→extraction residue (insoluble parts in %)
Fenton's test: after 96 hours in Fenton's reagent mass loss in %
impedance (resistance)
Water absorption at 90° C.

### Example 5 AEM from Sulfonated Polymer, PBI, Halomethylated Polymer, Tertiary Amine (Covalent-Ionically Cross-Linked)

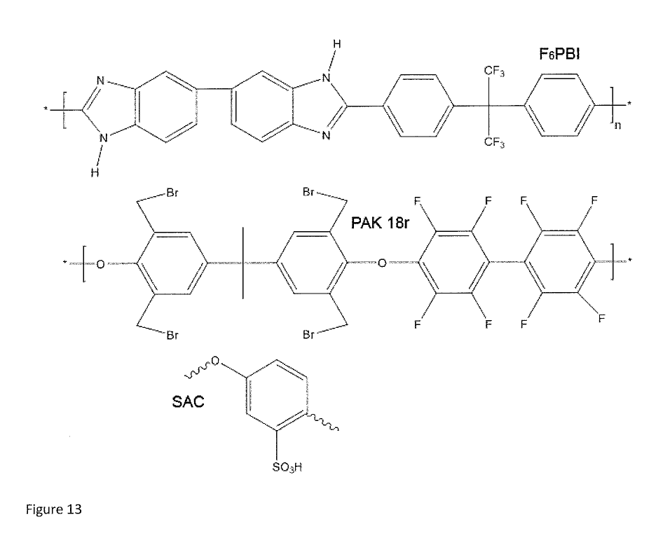

0.8 g of F₆PBI are mixed as a 5% solution in DMAc with 1.2 g of PARBr1 as a 5% solution in DMAc and 0.12 g of the sulfonated polymer sPPSU and 1.95 g of 1-ethyl-2-methylimidazole (the polymer blend components are depicted in FIG. 13).

After homogenization, a membrane is doctored on a glass plate from this solution, and the solvent is stripped off at 140° C. in a forced-air drying cabinet. The membrane is then removed under water and after-treated as follows: 48 hours of 10% HCl at 90° C., then 48 hours of deionized water at 60° C. Reaction of a small part of the CH₂Br groups with the imidazole-N—H under alkylation produces covalent crosslinking bridges.

The membrane is then characterized as follows:
Thermogravimetry (TGA) in 65% O₂
extraction with DMAc at 90° C. (4 days)→extraction residue (insoluble parts in %)
Fenton's test: after 96 hours in Fenton's reagent mass loss in %
impedance (resistance)
Water absorption at 90° C.

### Example 6 AEM from Sulfonated Polymer, F₆PBI, Halomethylated/Partially Fluorinated Polymer, Tertiary Mono- and Diamine (Covalent-Ionically Cross-Linked)

0.162 g of F₆PBI are mixed as a 5% solution in DMAc with 0.243 g of PAK 18r as a 5% solution in DMAc and 0.081 g of the sulfonated polymer sPPSU and 0.45 ml of the tertiary monoamine N-methylmorpholine (polymeric acid base blends).

After homogenization, a membrane is poured from this solution into a petri dish, and the solvent is stripped off at 80° C. in a forced-air drying cabinet. Subsequently, the membrane is removed under water and treated as follows: 48 hours in a mixture of 50/50 DABCO/EtOH at 80° C., then 48 hours in deionised water at 90° C. Reaction of a small part of the CH₂Br groups with the imidazole-N—H under alkylation produces covalent crosslinking bridges. The membrane is further covalently cross-linked by the diamine.

TABLE 2
Characterization parameters of the membrane
54-PAK18r-60-F₆PBI-SAC-15-NMM-DABCO

| | 54-PAK18r-60-F₆PBI-SAC- |
|---|---|
| Membrane | 15-NMM-DABCO |
| IEC value, mmol/g: | 2.0 |
| thickness, μm: | 60 |
| Cl⁻-σ (1 M, NaCl), mS/cm: | 10.1 |
| Alkaline stability, % of the | 92.8 |
| original value: | |
| (Cl⁻-σ after 5 d in 1 M KOH 90° C.) | |
| Extraction with DMAc. wt.-% | 96.3 |
| (insoluble share, after 4 d at 80° C.) | |
| Water uptake (30° C.), wt.-% | 66.9 |

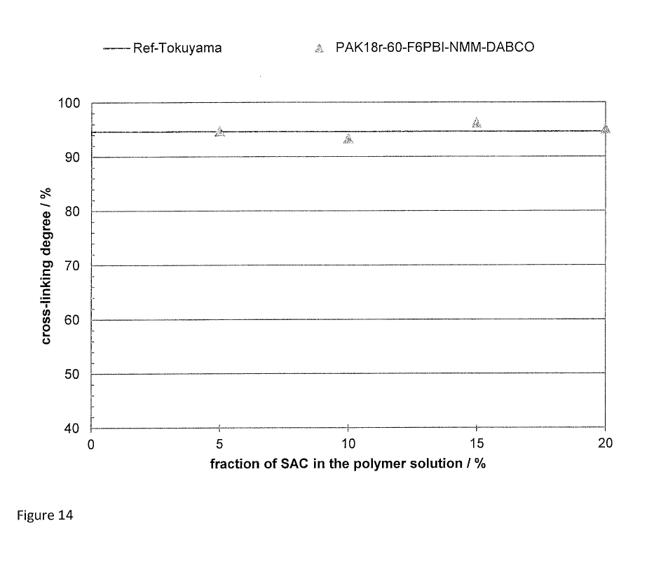

FIG. 14 shows the cross-linking degree in in dependence of the share of SAC in the polymer solution for membranes quaternized with NMM-DABCO from PAK18r-60-F₆PBI.

### Example 7: AEMs from PBIOO, Halomethylated Polymer, Alkylimidazole (Covalently Cross-Linked)

### 63-PPO-40-PBIOO-Melm

0.15 g of F₆PBI are mixed as a 5% solution in DMAc with 0.10 g of PPOBr as a 5% solution in DMAc and 0.26 ml of the imidazole compound 1-methylimidazole (polymer blends)

64-PPO-50-PBIOO-Melm:

0.125 g of F₆PBI are mixed as a 5% solution in DMAc with 0.125 g of PPOBr as a 5% solution in DMAc and 0.33 ml of the imidazole compound 1-methylimidazole (polymer blends)

67-PPO-50-PBIOO-EtMelm:

0.125 g of F₆PBI are mixed as a 5% solution in DMAc with 0.125 g of PPOBr as a 5% solution in DMAc and 0.47 ml of the imidazole compound 1-ethyl-2-methylimidazole (polymer blends)

After homogenization, a membrane is poured onto a petri dish from the polymer solution, and the solvent is stripped off at 80° C. in a circulating air drying cabinet. Subsequently, the membranes are removed under water and rinsed in demineralised water at 90° C. for 48 hours. Reaction of a small part of the CH₂Br groups with the imidazole-N—H under alkylation produces covalent crosslinking bridges. The membranes are characterized as follows:

TABLE 3
Characterization parameters of the alkylimidazole-quaternized PPO-PBIOO membranes

| | 63-PPO- | 64-PPO- | 67-PPO- |
|---|---|---|---|
| | 40-PBIOO- | 50-PBIOO- | 50-PBIOO- |
| Membrane | Melm | Melm | EtMelm |
| IEC value, mmol/g: | 4.5 | 4.1 | 3.5 |
| thickness, μm: | 35 | 33 | 45 |
| Cl⁻-σ (1 M, NaCl), mS/cm: | 6.4 | 16.9 | 15.1 |
| Alkaline stability, % of the original value: | 45.3 | 50.4 | 26.8 |
| (Cl⁻-σ after 5 d in 1 M KOH 90° C.) | | | |
| Cl⁻-σ (90% RF, 30° C.), mS/cm: | n. a. | 4.8 | 4.5 |
| Extraction with DMAc. wt.-% | 86.1 | 94.1 | 96.7 |
| (insoluble share, after 4 d at 80° C.) | | | |
| Water uptake (30° C.), wt.-% | 46.4 | 60.4 | 56.9 |

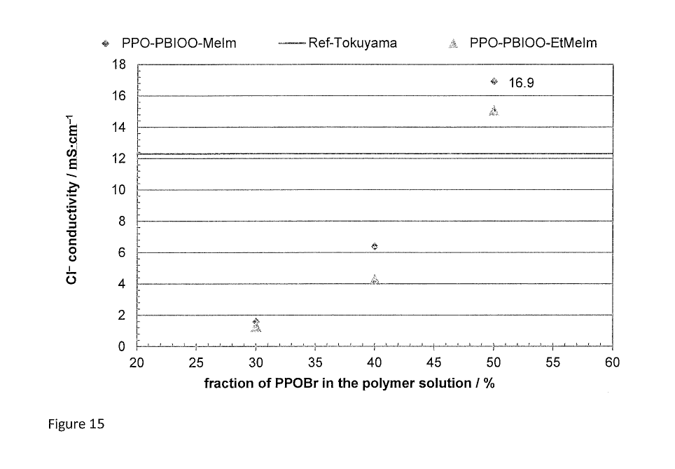

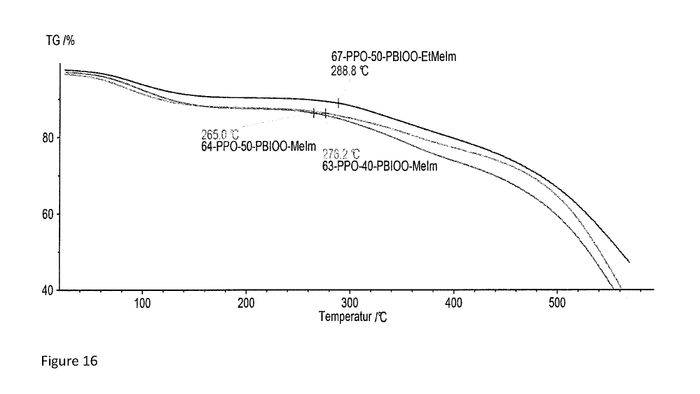

FIG. 15 shows the comparison of the chloride conductivities (1 M NaCl, RT) of the PPO-PBIOO membranes quenched with alkylimidazole and Tokuyama's commercial A201 (development code A006). Thermogravimetry (TGA) in 65% O₂ (the TGA traces of the membranes in application example 7 are depicted in FIG. 16).

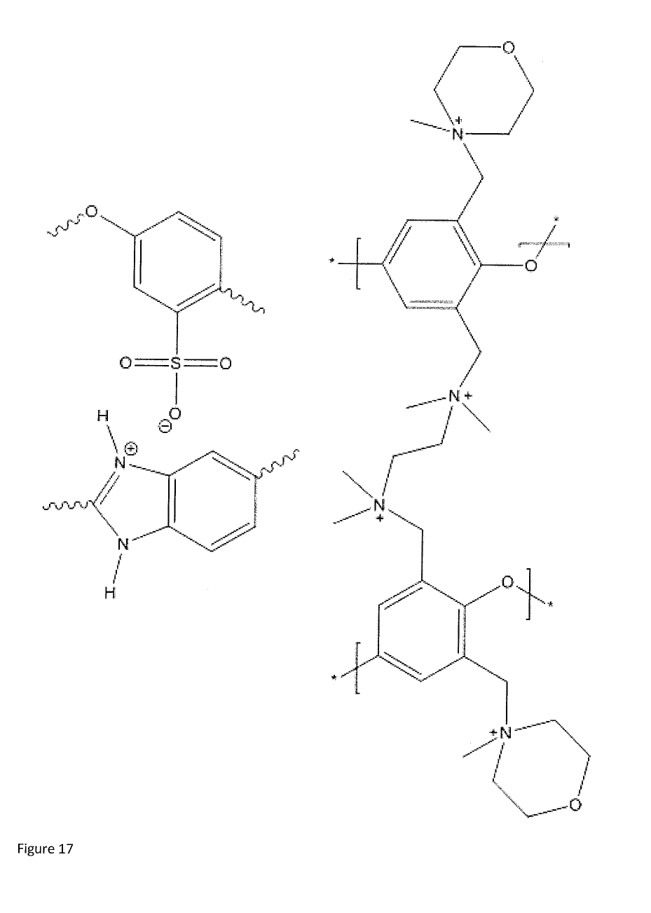

### Example 8: AEMs from (Sulfonated Polymer) F₆PBI, Halomethylated Polymer, Tertiary Mono- and Diamine (Covalently and or Ionically Cross-Linked (FIG. 17 Shows the Covalent and the Ionic Cross-Linking at the Blend Membrane 40-PPO-50-F₆PBI-SAC-5-NMM-TMEDA)

37-PPO-50-F₆PBI-NMM-TMEDA:

0.2025 g of F₆PBI are mixed as a 5% solution in DMAc with 0.2025 g of PPOBr as a 5% solution in DMAc and 0.44 ml of the tertiary monoamine N-methylmorpholine (covalently cross-linked polymer blends).

After homogenization, a membrane is poured from the solution onto a petri dish, and the solvent is stripped off at 80° C. in a re-circulated drying cabinet. Subsequently, the membrane is removed under water and after-treated as follows: 48 hours in TMEDA (1 d RT, 1 d 50° C.), then 48 hours in demineralized water at 90° C. Reaction of a small part of the CH₂Br groups with the imidazole-N—H under alkylation produces covalent crosslinking bridges. The membrane is further covalently cross-linked by the diamine.

40-PPO-50-F₆PBI-SAC-5-NMM-TMEDA:

0.2025 g of F₆PBI is added as a 5% solution in DMAc with 0.2025 g of PPOBr as a 5% solution in DMAc and 0.02025 g of the sulfonated polymer as a 5% solution in DMAc and 0.59 ml of the tertiary monoamine N-methylmorpholine (covalently cross-linked polymer blends)

After homogenization, a membrane is poured from the solution onto a petri dish, and the solvent is stripped off at 80° C. in a re-circulated drying cabinet. Subsequently, the membrane is stripped under water and treated as follows: 48 hours in TMEDA (1 d RT, 1 d 50° C., then 48 hours in demineralised water at 60° C. By reaction of a small part of the CH₂—Br groups with the imidazole —NH under alkylation, covalent crosslinking bridges are formed.

TABLE 5
Characterization parameters of PPO-F₆PBI membranes which are
(37) crosslinked only covalently and covalently-ionically (40)

| | 37-PPO-50- | 40-PPO-50-F₆PBI- |
|---|---|---|
| | F₆PBI-NMM- | SAC-5-NMM- |
| Membrane | TMEDA | TMEDA |
| IEC value, mmol/g: | n.a. | n.a. |
| Thickness, μm: | 45 | 40 |
| Cl⁻-σ (1 M, NaCl), mS/cm: | 12 | 5.3 |
| Alkaline stability, % of the | 41.6 | 82.3 |
| original value: | | |
| (Cl⁻-σ after 5 d in 1 M KOH 90° C.) | | |
| Extraction with DMAc, wt.-% | k.A. | k.A. |
| (insoluble share, after 4 d at 80° C.) | | |
| Water uptake (30° C.), wt.-% | 46.1 | 47.2 |

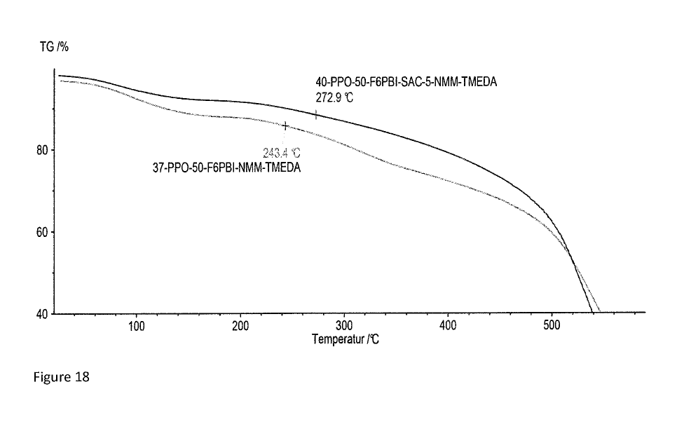

The TGA traces of the membranes in 65% O₂ are presented in FIG. 18.

### Example 9: AEMs from Sulfonated Polymer, F₆PBI, Halomethylated Polymer, Tertiary Mono- and Diamine (Covalently Ionically Cross-Linked)->44, 45, 46

0.2025 g of F₆PBI are added as a 5% solution in DMAc with 0.2025 g of PPOBr as a 5% solution in DMAc and, depending on the membrane, with 0.02025 g of SAC (44-PPO-50-F6PBI-SAC-5-NMM DABCO), 0.0405 g SAC (45-PPO-50-F6PBI-SAC-10-NMM-DABCO) or 0.06075 g SAC (46-PPO-50-F6PBI-SAC-15-NMM-DABCO) 5% solution in DMAc and 0.59 ml of the tertiary monoamine N-methylmorpholine (ionic-covalently cross-linked acid-base blends).

TABLE 6
Characterization parameters of the acid-base blends from PPO-F₆PBI, quaternized and crosslinked
with NMM/DABCO

| | 44-PPO-50- | 45-PPO-50- | 46-PPO-50-F₆PBI- |
|---|---|---|---|
| | F₆PBI-SAC-5- | F₆PBI-SAC-10- | SAC-15-NMM- |
| Membrane | NMM-DABCO | NMM-DABCO | DABCO |
| IEC value, mmol/g: | 2.5 | 2.5 | 2.6 |
| Thickness, μm: | 85 | 55 | 50 |
| Cl⁻-σ (1 M, NaCl), mS/cm: | 61.4 | 54.7 | 21.9 |
| Alkaline stability, % of | 78.4 | 38.6 | k.A. |
| the original value: | | | |
| (Cl⁻-σ after 5 d in 1 M KOH 90° C.) | | | |
| (Cl⁻-σ (90% RF, 30° C.), mS/cm: | n.a. | n.a. | n.a. |
| Extraction with DMAc, | 79.8 | 88.3 | 88.1 |
| wt.-% (insoluble share, | | | |
| after 4 d at 80° C.) | | | |
| Water uptake (30° C.), wt.-% | 159.3 | 133.9 | 107.5 |

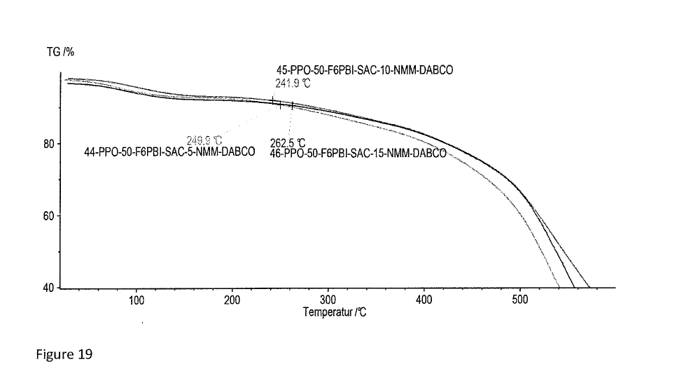

The TGA traces of the membranes in 65% O₂ are presented in FIG. 19.

### Example 10: AEMs from Sulfonated Polymer, F₆PBI, Halomethylated Polymer, Tertiary Monoamine (Covalently Ionically Cross-Linked)->71, 72, 73, 74, 75

0.2025 g of F₆PBI are added as a 5% solution in DMAc with 0.2025 g of PPOBr as a 5% solution in DMAc and, depending on the membrane, with 0.02025 g of SAC (71-PPO-50-F₆PBI-SAC-5-NMM), 0.0805 g SAC (72-PPO-50-F₆PBI-SAC-10-NMM), 0.0605 g SAC PPO-50-F₆PBI-SAC-20-NMM), or 0.5 g of the tertiary monoamine N-methylmorpholine (ionical-covalently crosslinked acid base-blends) After homogenization, a membrane is poured from the solution onto a petri dish, and the solvent is stripped off at 80° C. in a re-circulated drying cabinet. Subsequently, the membrane is stripped under water and treated as follows: 48 hours in 15% NMM in EtOH (1 d RT, 1 d 50° C.), then 48 hours in demineralised water at 90° C. Reaction of a small part of the CH₂Br groups with the imidazole-N—H under alkylation produces covalent crosslinking bridges. The oxygen atom belonging to the morpholine also contributes to further chain-crossing hydrogen bonds within the membrane.

TABLE 7
Characterization parameters of the acid-base blends from PPO-F₆PBI, quaternized with NMM

| | 71-PPO- | 72-PPO- | 73-PPO- | 74-PPO- | |
|---|---|---|---|---|---|
| | 50-F₆PBI- | 50-F₆PBI- | 50-F₆PB1- | 50-F₆PBI- | 75-PPO- |
| | SAC-5- | SAC-10- | SAC-15- | SAC-20- | 50-F₆PBI- |
| Membrane | NMM | NMM | NMM | NMM | NMM |
| IEC value, mmol/g: | n.a. | n.a. | n.a. | n.a. | n.a. |
| Thickness, μm: | 50 | 47 | 37 | 40 | 70 |
| Cl⁻-σ (1 M, NaCl), mS/cm: | 16.9 | 11.5 | 2.5 | 1.8 | 18.9 |
| Alkaline stability, % of the | 50.5 | 56.9 | 86.9 | 99.0 | k.A. |
| original value: | | | | | |
| (Cl⁻-σ after 5 d in 1 M KOH 90° C.) | | | | | |
| Cl⁻-σ (90% RF, 30° C.), mS/cm: | 5.2 | n.a. | n.a | n.a. | 6.5 |
| Extraction with DMAc. wt.-% | 100 | 100 | 99.1 | 93.5 | n.a. |
| (insoluble share, after 4 d at 80° C. | | | | | |
| Water uptake (30° C.), wt.-% | 54.0 | 58.7 | 39.4 | 39.0 | n.a. |

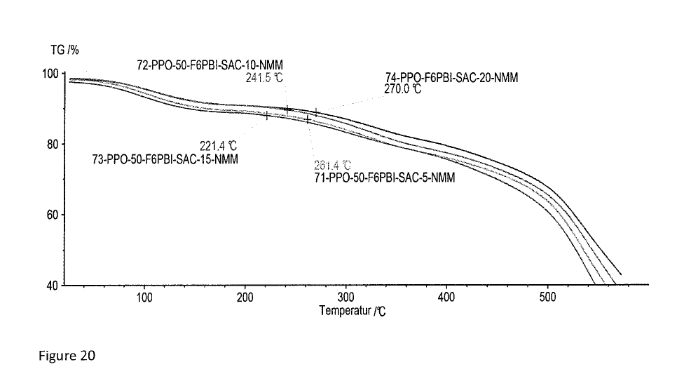

The TGA traces of the membranes in 65% O₂ are presented in FIG. 20.

### Example 11: AEMs from Different Blend Components

Table 8 shows the compositions of various AEM blends, and Table 9 shows some of their properties.

TABLE 8
Overview of some AEM blend types

| | Halomethylated | | Sulfonated | |
|---|---|---|---|---|
| | polymer | PBI | polymer | |
| | Type and | Type and | Type and | |
| Membrane | amount | amount | amount | Used tertiary |
| [No.] | [g] | [g] | [g] | N-Base |
| MCMA2 | PPOBr¹, 0.2025 | F₆PBI¹, 0.2025 | sPPSU², 0.02025 | N-methylmorpholine |
| MCMB3 | PARBr1², 0.243 | F₆PBI¹, 0.162 | sPPSU², 0.02025 | N-methylmorpholine |
| MCMC2 | PPOBr¹, 0.100 | PBIOO³, 0.150 | — | 1-methylimidazole |
| MCMD3 | PPOBr¹, 0.125 | PBIOO³, 0.125 | — | 1-ethyl-2-methylimidazole |
| MCME1 | PPOBr, 0.243 | F₆PBI¹, 0.162 | sPPSU², 0.02025 | 1-methylimidazole |
| MRP80 | PPOBr¹, 0.200 | F₆PBI¹, 0.133 | sPPSU², 0.01675 | 1-ethyl-2- |
| | | | | methylimidazole |
| MRP81 | PPOBr¹, 0.200 | F₆PBI¹, 0.133 | sPPSU², 0.01675 | 1,2-dimethylimidazole |
| MRP83 | PPOBr¹, 0.200 | F₆PBI¹, 0.133 | sPPSU², 0.01675 | 1-butyl-2- |
| | | | | methylimidazole |
| MJK2025 | PVBCl³, 0.500 | F₆PBI¹, 0.400 | sPPSU², 0.032 | 1,2-dimethylimidazole |
| MJK2026 | PVBCl³, 0.500 | F₆PBI¹, 0.400 | — | 1,2-dimethylimidazole |
| Tokuyama | — | — | — | Tertiary amine |
| A201 | | | | (unknown) |

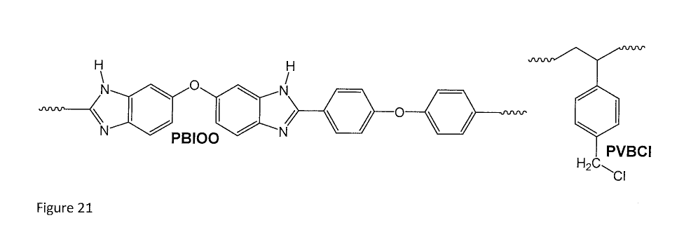

¹Structural formula (repeat unit) of PPOBr and F₆PBI is depicted in Figure 5
²Structural formula (repeat unit) of PARBr¹ and sPPSU is depicted in Figure 8
³Structural formula (repeat unit) of PBIOO and PVBCl is depicted in Figure 21

TABLE 9
Some characterization results of these AEM blends

| | | | | σ_{Cl} | |
|---|---|---|---|---|---|
| | | | | after | |
| | | Water | | KOH¹ | |
| | IEC | uptake | | [% of | |
| Membrane | [mmol | at 30° C. | σ_{Cl-} | initial | Tₒₙₛₑₜ² |
| [No.] | OH⁻/g] | [%] | [mScm⁻¹] | value] | [° C.] |
| MCMA2 | 1.8 | 47 | 17 | 62 | 273 |
| MCMB3 | 2.5 | 67 | 10 | 58 | 232 |
| MCMC2 | 4.5 | 46 | 6 | 36 | 245 |
| MCMD3 | 3.3 | 57 | 15 | 41 | 289 |
| MCME1 | 2.7 | 74 | 8 | 69 | 254 |
| MRP80 | 2.46 | 56 (25° C.) | 16 | 70.9 | n.a. |
| MRP81 | 2.5 | 51.5 (25° C.) | 17 | 40.6 | n.a. |
| MRP83 | 2.4 | 51.8 (25° C.) | 10 | 31.6 | n.a. |
| MJK2025 | 2.31 | n.a. | 34.1 | 32.8 | n.a. |
| MJK2026 | 2.59 | n.a. | 34 | 47.6 | n.a. |
| Tokuyama | 1.7 | 19 | 2.4 | 21 | 166 |
| A201 | | | | | |

¹value after storage in 1 molar KOH at 90° C. for 10 days (240 hours)
²Start of decomposition of the polymer (determined by TGA-FTIR coupling)

It can be clearly seen from Table 9 that all the AEM blend membranes studied have better chemical stability both after the KOH immersion and in the TGA experiment than the commercial benchmark membrane Tokuyama A201.

Due to their excellent properties, conductivity and long-term stability in alkaline media, the membranes are particularly suitable for sensors, especially ion-selective sensors and ion-selective applications, and for alkaline fuel cells.

### REFERENCES

¹Wainright, J. S.; Wang, J. T.; Savinell, R. F.; Litt, M. J. Electrochem. Soc. 142, L121-L123 (1995)
²Kreuer, K. D.; Paddison, S.; Spohr, E.; Schuster, M. Chem. Rev. 104, 4637-4678 (2004)
³Yu, S.; Xiao, L.; Benicewicz, B. C. Fuel Cells 8, 165-174 (2008)
⁴Liao, J.; Li, Q.; Rudbeck, H. C.; Jensen, J. O.; Chromik, A.; Bjerrum, N. J.; Kerres, J.; Xing, W. Fuel Cells 11, 745-755 (2011)
⁵Kerres, J.; Ullrich, A.; Meier, F.; Häring, T. Solid State Ionics 125, 243-249 (1999)
⁶Kerres, J.; Schönberger, F.; Chromik, A.; Häring, T.; Li, Q.; Jensen, J. O.; Pan, C.; Noyé, P.; Bjerrum N. J. Fuel Cells 8, 175-187 (2008)
⁷Atanasov, V.; Kerres, J. Macromolecules 44, 6416-6423 (2011)
⁸Highly phosphonated polypentafluorostyrene: characterization and blends with polybenzimidazole. Atanasov, V.; Gudat, D.; Ruffmann, B.; Kerres, J. Eur. Poly, J., 2013, 49, 3977-3985
⁹Wang, S.; Zhang, G.; Han, M.; Li, H.; Zhang, Y.; Ni, J.; Ma, W.; Li, M.; Wang, J.; Liu, Z.; Zhang, L.; Na, H. Int. J. Hydrogen En. 36, 8412-8421 (2011)
¹⁰Aili, D.; Li, Q.; Christensen, E.; Jensen, J. O.; Bjerrum, N. J. Polym. Int. 60, 1201-1207 (2011)
¹¹Yang, J.; Li, Q.; Cleemann, L. N.; Jensen, J. O.; Pan, C.; Bjerrum, N. J., He, R. Adv. En. Mater. 3, 622-630 (2013)
¹²Wang, S.; Zhao, C.; Ma, W.; Zhang, N.; Liu, Z.; Zhang, G.; Na, H. J. Power Sources 243, 102-109 (2013)
¹³Plackett, D.; Siu, A.; Li, Q.; Pa, C.; Jensen, J. O.; Nielsen, S. F.; Permyakova, A. A.; Bjerrum N. J. J. Memb. Sci. 383, 78-87 (2011)
¹⁴Jones, D. J.; Roziere, J. J. Memb. Sci. 185, 41-58 (2001)
¹⁵Peron, J.; Ruiz, E.; Jones, D.; Roziere, J. J. Memb. Sci. 314, 247-256 (2008)
¹⁶Sukumar, P. R.; Wu, W.; Markova, D.; Ünsal, b.; Klapper, M.; Müllen, K. Macromol. Chem., Phys. 208, 2258-2267 (2007)
¹⁷Sinigersky, V.; Budurova, D.; Penchev, H.; Ublekov, F.; Radev, I. J. Appl. Polym. Sci. 129, 1223-1231 (2013)
¹⁸Kerres, J.; Ullrich, A.; Häring, T. Engineering ionorneric blends and engineering ionomeric blend membranes, U.S. Pat. No. 6,723,757B1, Apr. 20, 2004
¹⁹Wright, A.; Thomas, O.; Holdcroft, S. Anion-conducting polymer, WO2013149328 (PCT/CA2013/000323) Priority date 4 Apr. 2012
²⁰Thomas, O. D.; Soo, K. J. W. Y.; Peckham, T. J.; Kulkami, M. P.; Holdcroft, S. J. Am. Chem. Soc. 134 (2012) 10753-10756
²¹Yanagi, H.; Fukuta, K. ECS Trans. 2008 16(2), S. 257-262 (2008)
²²Yang, C.-C. Materials Science and Engineering: B 131 (1-3), S. 256-262 (2006)
²³Patent: European Patent 1 612 874 A1, El Moussaoui, Rachid; Martin, Roland. applicant: SOLVAY (Société Anonyme) 1050 Brüssel (2006)
²⁴Varcoe, J. R. Physical Chemistry Chemical Physics 9, S. 1479-1486 (2007)
²⁵Wu, L.; Xu, T. J Membr Sci; 322:286-92 (2008)
²⁶Hibbs, M. R.; Fujimoto, C. H.; Cornelius, C. J. Macromolecules 42, S. 8316-8321 (2009)
²⁷Robertson, Nicholas J.; Kostalik I V, Henry A.; Clark, Timothy J.; Mutolo, Paul F.; Abruña, Héctor D.; Coates, Geoffrey W. (2010): Tunable high performance cross-linked alkaline anion exchange membranes for fuel cell applications. In: Journal of the American Chemical Society 132, S. 3400-3404. DOI: 10.1021/ja908638d8
²⁸Kostalik, H. A.; Clark, T. J.; Robertson, N.J.; Mutolo, P. F.; Longo, J. M.; Abruña, H. c. D; Coates, G. W. Macromolecules 43, S. 7147-7150 (2010)
²⁹Wang, J.; Li, S.; Zhang, S. Macromolecules 43, S. 3890-3896 (2010).
³⁰Tanaka, M.; Masaki K.; Miyatake, K.; Watanabe, M. Macromolecules 43, S. 2657-2659 (2010).
³¹Tanaka, M.; Fukasawa, K.; Nishino, E.; Yamaguchi, S.; Yamada, K.; Tanaka, H.; Bae, B.; Miyatake, K.; Watanabe, M. J. Am. Chem. Soc. 133, S. 10646-10654 (2011)
³²Zhao, Z.; Wang, J.; Li, S-; Zhang, S. Journal of Power Sources 196 (10), S. 4445-4450 (2011)
³³Faraj, M.; Elia, E.; Boccia, M.; Filpi, A.; Pucci, A.; Ciardelli, F. Journal of Polymer Science Part A: Polymer Chemistry, 49, S. 3437-3447 (2011)
³⁴Ran, J.; Wu, L.; Varcoe, J. R.; Ong, A. L.; Poynton, S. D.; Xu, T. Journal of Membrane Science 415-416, S. 242-249 (2012)
³⁵Lin, X.; Wu, L.; Liu, Y.; Ong, A. L.; Poynton, S. D.; Varcoe, J. R.; Xu, T. Journal of Power Sources 217, S. 373-380 (2012)
³⁶Wang, J.; He, G.; Wu, X.; Yan, X.; Zhang, Y.; Wang, Y.; Du, L. Journal of Membrane Science 459, S. 86-95 (2014)
³⁷Yan, X.; Gu, S.; He, G.; Wu, X.; Zheng, W.; Ruan, X. Journal of Membrane Science 466, S. 220-228 (2014)

1. Membrane characterized in that it is consisting of any mixing ratios from the polymeric membrane components:
halomethylated polymer (polymer with CH₂HaI groups, with HaI═F, Cl, Br, I)
polymer with cation exchange groups SO₃X or PO₃X₂ (counterion arbitrary, preferred X═H, metal cation, ammonium cation, imidazolium cation, pyridinium cation, etc.)
polymer with tertiary N-basic groups
and, if appropriate, any chemical compound or a mixture of chemical low- or high-molecular-weight compounds having tertiary N groups.

2. Membrane according to claim 1, characterized in that
the halomethylated polymer(s) is (are) selected from arylene main chain polymers with CH₂-HaI side groups
the cation exchange polymer or polymers are selected from sulfonated polymers
the tertiary N-basic polymers or polymers are selected from polyimidazoles, polybenzimidazoles, polyimides, polyoxazoles, polyoxadiazoles, polypyridines or aryl polymers having tertiary N-basic functional groups
the tertiary N-basic compound(s) is (are) selected from tertiary amines (mono- and diamines) and/or N-monoalkylated and/or N-monoarylated imidazoles, N-monoalkylated or N-monoarylated benzimidazoles, monoalkylated or monoarylated pyrazoles.

3. Membrane according to claim 1, characterized in that the polymeric membrane component containing the cation exchange groups is present in molar excess and is thus a cationic conductor (cation exchange membrane CEM).

4. The membrane as claimed in claim 1, wherein the polymer membrane component containing the anion exchange groups is present in molar excess and is thus an anionic conductor (anion exchange membrane AEM).

5. The membrane as claimed in claim 1, wherein the polymeric membrane component containing N-basic groups is present in molar excess and is thus a proton conductor after doping with phosphoric acid, phosphonic acid, sulfuric acid or other 2- or 3-basic acids which can be used in the temperature range>100° C.

6. A process for producing membranes as claimed in claim 1, wherein all polymeric membrane components are mixed and homogenized in a common solvent, a membrane is sprayed, doctored or cast from the resulting solution, the solvent then evaporating at elevated temperatures, the membrane is thereafter detached from the support and finally treated by various methods in order to activate the membrane.

7. Process according to claim 6, characterized in that dipolar aprotic solvents such as N, N-dimethylacetamide, N-methylpyrrolidinone, N,N-dimethylformamide, dimethylsulfoxide, N-ethylpyrrolidinone, diphenylsulfone, sulfolane are used as solvents for dissolving the polymers.

8. The method as claimed in claim 6, wherein the following post-treatment process is used: (a) soaking in dilute mineral acid at T=room temperature (RT) to 100° C.; (B) soaking in deionized water at room temperature to 100° C.; (C1), if desired, soaking in concentrated phosphoric or phosphonic acid at T=RT up to 150° C. for the preparation of a doped intermediate temperature proton conductor (T=100-220° C.); or (C2), if desired, in dilute alkali metal hydroxide solutions, followed by immersion in demineralized water to produce the OH⁻ form of anion exchange membranes (AEM).

9. Use of the membranes according to claims 1 to 8 in membrane processes, especially in PEM low temperature fuel cells, PEM medium temperature fuel cells, PEM electrolysis, SO₂-depolarized electrolysis, redox flow batteries, electrodialysis, diffusion dialysis, nanofiltration, ultrafiltration, reverse osmosis and pressure-retarded osmosis.

10. Use of the membranes as a component of sensors, electrodes, secondary batteries, fuel cells, alkaline fuel cells or membrane electrode assemblies.
